(19) United States
(12) Patent Application Publication
(10) Pub. No.: US 2021/0312192 A1
(43) Pub. Date: Oct. 7, 2021

(54) METHOD AND DEVICE FOR IMAGE PROCESSING AND STORAGE MEDIUM

(71) Applicant: SHENZHEN SENSETIME TECHNOLOGY CO., LTD., Shenzhen (CN)

(72) Inventors: Hang Chen, Shenzhen (CN); Feng Zhu, Shenzhen (CN)

(21) Appl. No.: 17/348,878

(22) Filed: Jun. 16, 2021

Related U.S. Application Data
(63) Continuation of application No. PCT/CN2019/125297, filed on Dec. 13, 2019.

(30) Foreign Application Priority Data
Nov. 27, 2019 (CN) 201911182723.7

(51) Int. Cl. G06K 9/00; G06K 9/46; G06F 17/15

(52) U.S. Cl. CPC G06K 9/00778; G06F 17/15; G06K 9/4671

(57) ABSTRACT

A method and a device for image processing and a storage medium are provided. The method includes: obtaining an image to be processed, a first convolution kernel and a second convolution kernel, a receptive field of the first convolution kernel being different from a receptive field of the second convolution kernel; obtaining a first feature image by performing a convolution process on the image to be processed using the first convolution kernel, and obtaining a second feature image by performing a convolution process on the image to be processed using the second convolution kernel; and obtaining a first crowd density image by performing a fusion process on the first feature image and second feature image. A corresponding device is further disclosed.

### CROSS-REFERENCE TO RELATED APPLICATION

The present Application is a continuation of International Patent Application No. PCT/CN2019/125297, filed on Dec. 13, 2019, which claims priority to Chinese Patent Application No. 201911182723.7, filed to the China National Intellectual Property Administration on Nov. 27, 2019 and entitled “Method and Device for Image Processing, Processor, Electronic Equipment and Storage Medium”. The contents of International Patent Application No. PCT/CN2019/125297 and Chinese Patent Application No. 201911182723.7 are incorporated herein by reference in their entireties.

### BACKGROUND

When there is too much human traffic in a public place, a public event such as a stampede is likely to occur. Therefore, how to implement crowd counting for a public place is of great significance.

A conventional method is based on a deep learning technology. An image of a public place may be processed to extract feature information of the image, a crowd density image corresponding to the image of the public place may be determined according to the feature information, and furthermore, a number of people in the image of the public place may be determined according to the crowd density image, to implement the crowd counting.

### SUMMARY

The application relates to the technical field of image processing, and particularly to a method and a device for image processing, a processor, electronic equipment and a storage medium.

In a first aspect, a method for image processing is provided. The method includes: obtaining an image to be processed, a first convolution kernel and a second convolution kernel, a receptive field of the first convolution kernel being different from a receptive field of the second convolution kernel; performing a convolution process on the image to be processed using the first convolution kernel to obtain a first feature image, and performing a convolution process on the image to be processed using the second convolution kernel to obtain a second feature image; and performing a fusion process on the first feature image and second feature image to obtain a first crowd density image.

In a second aspect, a device for image processing is provided. The device includes a processor; and a memory for storing processor-executable instructions; wherein the processor is configured to execute the instructions to perform operations of: obtaining an image to be processed, a first convolution kernel, and a second convolution kernel, a receptive field of the first convolution kernel being different from a receptive field of the second convolution kernel; obtaining a first feature image by performing a convolution process on the image to be processed using the first convolution kernel, and obtaining a second feature image by performing a convolution process on the image to be processed using the second convolution kernel; and obtaining a first crowd density image by performing a fusion process on the first feature image and second feature image.

In a third aspect, a computer-readable storage medium is provided. The storage medium has stored thereon a computer program including a program instruction which, when executed by a processor of electronic equipment, causes the processor to perform a processor; and a memory for storing processor-executable instructions; wherein the processor is configured to execute the instructions to perform operations of: obtaining an image to be processed, a first convolution kernel, and a second convolution kernel, a receptive field of the first convolution kernel being different from a receptive field of the second convolution kernel; obtaining a first feature image by performing a convolution process on the image to be processed using the first convolution kernel, and obtaining a second feature image by performing a convolution process on the image to be processed using the second convolution kernel; and obtaining a first crowd density image by performing a fusion process on the first feature image and second feature image.

It is to be understood that the foregoing general description and the following detailed description are only exemplary and explanatory and not intended to limit the disclosure.

### BRIEF DESCRIPTION OF THE DRAWINGS

In order to describe the technical solutions in the embodiments of the disclosure or a background art more clearly, the drawings required for the embodiments or the background of the disclosure will be described below.

The accompanying drawings, which are incorporated in and constitute a part of the specification, illustrate embodiments consistent with the disclosure and, together with the specification, serve to describe the technical solutions of the disclosure.

FIG. 1 is a flowchart of a method for image processing according to at least one embodiment of the disclosure.

FIG. 2A is a schematic diagram of a convolution kernel according to at least one embodiment of the disclosure.

FIG. 2B is a schematic diagram of a weight of a convolution kernel according to at least one embodiment of the disclosure.

FIG. 3 is a schematic diagram of elements at the same positions according to at least one embodiment of the disclosure.

FIG. 4 is a schematic diagram of a crowd image according to at least one embodiment of the disclosure.

FIG. 5 is a flowchart of another method for image processing according to at least one embodiment of the disclosure.

FIG. 6A is a schematic diagram of an atrous convolution kernel according to at least one embodiment of the disclosure.

FIG. 6B is a schematic diagram of another atrous convolution kernel according to at least one embodiment of the disclosure.

FIG. 7 is a schematic diagram of another atrous convolution kernel according to at least one embodiment of the disclosure.

FIG. 8 is a structure diagram of a crowd counting network according to at least one embodiment of the disclosure.

FIG. 9 is a structure diagram of a scale-aware convolutional layer according to at least one embodiment of the disclosure.

FIG. 10 is a structure diagram of a device for image processing according to at least one embodiment of the disclosure.

FIG. 11 is a hardware structure diagram of a device for image processing according to at least one embodiment of the disclosure.

### DETAILED DESCRIPTION

To make the solutions of the disclosure better understood by those skilled in the art, the technical solutions of the embodiments of the disclosure are clearly and comprehensively described below in combination with the drawings of the embodiments of the disclosure. It is apparent that the described embodiments are not all but only part of the embodiments of the disclosure. All the other embodiments obtained by those skilled in the art based on the embodiments in the disclosure without creative work shall fall within the scope of protection of the disclosure.

The terms “first”, “second” or the like in the specification, claims and drawings of the disclosure are not used to describe a specific sequence but to distinguish among different objects. In addition, the terms “include” and “have” and any transformations thereof are intended to cover nonexclusive inclusions. For example, a process, method, system, product or device including a series of steps or units is not limited to the steps or units which have been listed but may further includes steps or units which are not listed or may further includes other steps or units intrinsic to the process, the method, the product or the device.

The “embodiment” mentioned in the disclosure means that a specific feature, structure or characteristic described in combination with an embodiment may be included in at least one embodiment of the disclosure. Each position where this phrase appears in the specification does not always refer to the same embodiment, or an independent or alternative embodiment mutually exclusive with other embodiments. It is explicitly and implicitly understood by those skilled in the art that the embodiments described in the disclosure may be combined with other embodiments.

In a public place (for example, a plaza, a supermarket, a subway station and a wharf), there may be too much human traffic sometimes, which leads to overcrowding. In such a case, some public accidents are likely to occur, for example, a stampede. Therefore, how to implement crowd counting for a public place becomes quite significant.

With the development of the deep learning technology, the number of people in an image may be determined with a method based on deep learning, thereby implementing crowd counting. According to a conventional deep learning method, a convolution process is performed on a whole image using one convolution kernel to extract feature information in the image, and the number of people in the image is determined according to the feature information. Since the receptive field of one convolution kernel is fixed, performing the convolution process on the whole image using one convolution kernel is equivalent to performing convolution processes on contents of different scales in the image based on the same receptive field. However, different people in the image have different scales, which would lead to uneffective extraction of the scale information in the image, and would further lead to an error of the determined number of people.

In the disclosure, a person close up in an image corresponds to a large image scale, and a person far away in the image corresponds to a small image scale. In the embodiments of the disclosure, “far away” refers to a long distance between a real person corresponding to the person in the image and an imaging device acquiring the image, and “close up” refers to a short distance between a real person corresponding to the person in the image and the imaging device acquiring the image.

In a convolutional neural network, a receptive field is defined as a size of a region in an input picture mapped by pixels on a feature map output by each layer of the convolutional neural network. In the disclosure, a receptive field of a convolution kernel is a receptive field for a convolution process performed on an image using the convolution kernel.

According to the technical solutions provided in the embodiments of the disclosure, the scale information in an image may be extracted, and the accuracy of the determined number of people may be further improved.

The embodiments of the disclosure are described below in combination with the drawings of the embodiments of the disclosure.

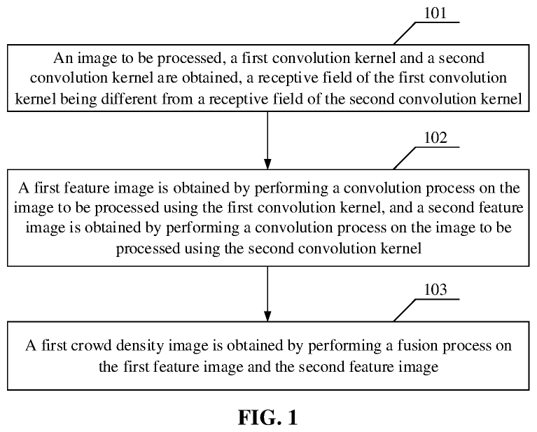

Referring to FIG. 1, FIG. 1 is a flowchart of a method for image processing according to the first embodiment of the disclosure.

In 101, an image to be processed, a first convolution kernel and a second convolution kernel are obtained, a receptive field of the first convolution kernel being different from a receptive field of the second convolution kernel.

An executive body of the embodiment of the disclosure may be terminal hardware such as a server, a mobile phone, a computer and a tablet computer. The method provided in the embodiment of the disclosure may be further performed in a manner that a processor runs computer-executable codes. The image to be processed may be any image. For example, the image to be processed may include a person object. The image to be processed may merely include a face without trunk and limbs (the trunk and the limbs are hereafter referred to as a human body), or may merely include a human body without a face, or may merely include the lower limbs or the upper limbs. A specific human body region in the image to be processed is not limited in the disclosure. For another example, the image to be processed may include an animal. For still another example, the image to be processed may include a plant. The content in the image to be processed is not limited in the disclosure.

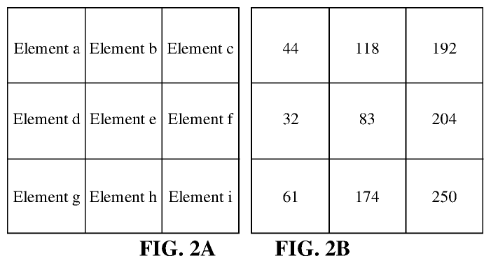

Before the following elaborations, the meaning of a weight of a convolution kernel in the embodiment of the disclosure is defined at first. In the embodiment of the disclosure, a convolution kernel of which a channel number is 1 exists in form of an n*n matrix. The matrix includes n*n elements, and each element has a value. The value of the element in the matrix is a weight of the convolution kernel. In a 3*3 convolution kernel illustrated in FIG. 2A, when a value of an element a is 44, a value of an element b is 118, a value of an element c is 192, a value of an element d is 32, a value of an element e is 83, a value of an element f is 204, a value of an element g is 61, a value of an element is 174 and a value of an element i is 250, a weight of the 3*3 convolution kernel is a 3*3 matrix illustrated in FIG. 2B.

In the embodiment of the disclosure, under the condition that the receptive field of the first convolution kernel is different from the receptive field of the second convolution kernel, each of the first convolution kernel and second convolution kernel may be a convolution kernel of any size, and each of a weight of the first convolution kernel and a weight of the second convolution kernel may be any natural number. The size of the first convolution kernel, the size of the second convolution kernel, the weight of the first convolution kernel and the weight of the second convolution kernel are not limited in the embodiment.

The image to be processed may be obtained by receiving the image to be processed which is input by a user through an input component, and alternatively, may be obtained by receiving the image to be processed sent by a terminal. The first convolution kernel may be obtained by receiving the first convolution kernel which is input by the user through the input component, and alternatively, may be obtained by receiving the first convolution kernel sent by the terminal. The second convolution kernel may be obtained by receiving the second convolution kernel which is input by the user through the input component, and alternatively, may be obtained by receiving the second convolution kernel sent by the terminal. The input component includes a keyboard, a mouse, a touch screen, a touch pad, an audio input unit or the like. The terminal includes a mobile phone, a computer, a tablet computer, a server or the like.

In 102, a first feature image is obtained by performing a convolution process on the image to be processed using the first convolution kernel, and a second feature image is obtained by performing a convolution process on the image to be processed using the second convolution kernel.

Since the receptive field of the first convolution kernel is different from the receptive field of the second convolution kernel, performing the convolution process on the image to be processed using the first convolution kernel and performing the convolution process on the image to be processed using the second convolution kernel is equivalent to “observing” the image based on different receptive fields to obtain the image information under different scales. That is, each of the first feature image and second feature image includes information configured to describe the content of the image to be processed, but the scale of the information included in the first feature image is different from the scale of the information included in the second feature image.

In 103, a first crowd density image is obtained by performing a fusion process on the first feature image and second feature image.

In the embodiment of the disclosure, the crowd density image includes crowd density information. A pixel value of each pixel in the crowd density image represents the number of people at the pixel. For example, when a pixel value of pixel A in the crowd density image is 0.05, there is 0.05 person at pixel A.

It is to be understood that an image region covered by a person includes at least one pixel, when the image region covered by the person is 1 pixel, the pixel value corresponding to the pixel is 1, and when the image region covered by the person is at least two pixels, a sum of pixel values of the at least two pixels is 1. Therefore, a range of the pixel value of the crowd density image is more than or equal to 0 and less than or equal to 1. For example, when an image region covered by person A includes pixel a, pixel b and pixel c, (the pixel value of pixel a)+(the pixel value of pixel b)+(the pixel value of pixel c)=1.

The first crowd density image is a crowd density image corresponding to the image to be processed and may represent a crowd density distribution in the image to be processed. A size of the first crowd density image is the same as a size of the image to be processed. In the embodiment, a size of an image refers to a width and height of the image. A pixel value of a first pixel in the first crowd density image may be used for representing the number of people at a second pixel in the image to be processed. A position of the first pixel in the first crowd density image is the same as a position of the second pixel in the image to be processed.

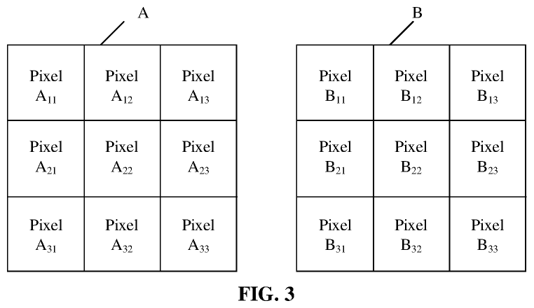

In the embodiment of the disclosure, for the pixels at the same positions in two images, references may be made to FIG. 3. As illustrated in FIG. 3, a position of pixel A₁₁ in image A is the same as a position of pixel B₁₁ in image B, a position of pixel A₁₂ in image A is the same as a position of pixel B₁₂ in image B, a position of pixel A₁₃ in image A is the same as a position of pixel B₁₃ in image B, a position of pixel A₂₁ in image A is the same as a position of pixel B₂₁ in image B, a position of pixel A₂₂ in image A is the same as a position of pixel B₂₂ in image B, a position of pixel A₂₃ in image A is the same as a position of pixel B₂₃ in image B, a position of pixel A₃₁ in image A is the same as a position of pixel B₃₁ in image B, a position of pixel A₃₂ in image A is the same as a position of pixel B₃₂ in image B, and a position of pixel A₃₃ in image A is the same as a position of pixel B₃₃ in image B.

When a position of pixel x in image X is the same as a position of pixel y in image Y, for simplicity, pixel x is referred to as a pixel in image X at the same position as pixel y hereinafter, or pixel y is referred to as a pixel in image Y at the same position as pixel x.

Since the scale of the information included in the first feature image which describes the image content of the image to be processed is different from the scale of the information included in the second feature image which describes the image content of the image to be processed, the fusion process (for example, a weighting process for the pixel values of corresponding positions) may be performed on the first feature image and second feature image, and the crowd density image corresponding to the image to be processed, i.e., the first crowd density image, may be generated by using the information describing the image content of the image to be processed under different scales. In such a manner, the accuracy of the obtained crowd density image corresponding to the image to be processed may be improved, and the accuracy of the obtained number of people in the image to be processed may be further improved.

It is to be understood that, the embodiment elaborates obtaining the information describing the image content of the image to be processed under two scales by performing convolution processes on the image to be processed using two convolution kernels with different receptive fields (i.e., the first convolution kernel and second convolution kernel) respectively. However, in a practical application, the convolution processes may be alternatively performed on the image to be processed using three or more convolution kernels with different receptive fields respectively to obtain the information describing the image content of the image to be processed under three or more scales, and the information describing the image content of the image to be processed under three or more scales is fused to obtain the crowd density image corresponding to the image to be processed.

Optionally, after the first crowd density image is obtained, the number of people in the image to be processed may be obtained by determining a sum of pixel values of all pixels in the first crowd density image.

In the embodiment, the convolution processes are performed on the image to be processed using the first convolution kernel and second convolution kernel with different receptive fields respectively, so as to extract the information describing the content of the image to be processed under different scales and obtain the first feature image and second feature image respectively. The fusion process is performed on the first feature image and second feature image, so as to improve the accuracy of the obtained crowd density image corresponding to the image to be processed using the information describing the content of the image to be processed under different scales, and to further improve the accuracy of the obtained number of people in the image to processed.

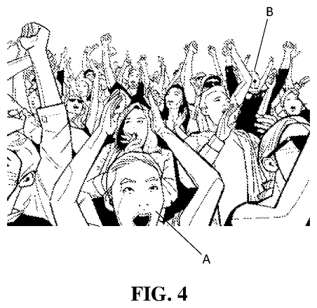

In an image, an acreage of an image region covered by a person close up is larger than an acreage of an image region covered by a person far away. For example, in FIG. 4, person A, compared with person B, is a person close up, and an acreage of an image region covered by person A is larger than an acreage of an image region covered by person B. The scale of the image region covered by the person close up is large, and the scale of the image region covered by the person far away is small. Therefore, the acreage of the image region covered by a person is positively correlated with the scale of the image region covered by the person. It is apparent that, when the receptive field for the convolution process is the same as the acreage of the image region covered by the person, the richest information of the image region covered by the person may be obtained through the convolution process (the receptive field with which the richest information of the image region covered by the person may be obtained is referred to as an optimal receptive field of the region covered by the person hereinafter). That is, the scale of the image region covered by the person is positively correlated with the optimal receptive field of the region covered by the person.

In the first embodiment, the convolution processes are performed on the image to be processed using the first convolution kernel and second convolution kernel with different receptive fields respectively to obtain the information describing the content of the image to be processed under different scales. However, both the receptive field of the first convolution kernel and the receptive field of the second convolution kernel are fixed, and the scales of different image regions in the image to be processed are different, such that an optimal receptive field of each image region in the image to be processed may not be obtained by performing the convolution processes on the image to be processed using the first convolution kernel and second convolution kernel respectively, i.e., the obtained information of different image regions in the image to be processed may not be the richest. Therefore, the embodiment of the disclosure further provides a method of weighting the first feature image and second feature image during the fusion process for the first feature image and second feature image, so as to implement the convolution processes on the image regions of different scales in the image to be processed based on different receptive fields, and further to obtain richer information.

In the embodiment, the convolution processes are performed on the image to be processed using the first convolution kernel and second convolution kernel respectively, which have different receptive fields, to extract information describing a content of the image to be processed under different scales, and to obtain the first feature image and second feature image respectively. The fusion process is performed on the first feature image and second feature image, so as to take advantage of the information describing the content of the image to be processed under the different scales, thereby further improving the accuracy of the obtained crowd density image corresponding to the image to be processed.

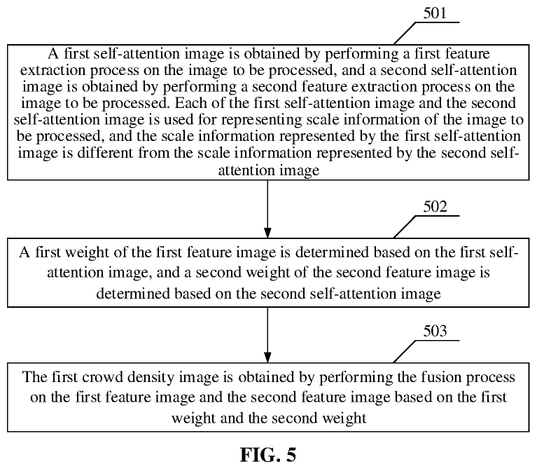

Referring to FIG. 5, FIG. 5 is a flowchart of another method for image processing according to the second embodiment of the disclosure.

In 501, a first self-attention image is obtained by performing a first feature extraction process on the image to be processed, and a second self-attention image is obtained by performing a second feature extraction process on the image to be processed. Each of the first self-attention image and second self-attention image is used for representing scale information of the image to be processed, and the scale information represented by the first self-attention image is different from the scale information represented by the second self-attention image.

In the embodiment of the disclosure, the feature extraction process may be a convolution process, or may be a pooling process, or may be a combination of the convolution process and the pooling process. The implementation of the first feature extraction process and the implementation of the second feature extraction process are not limited in the disclosure.

In a possible implementation, a multi-stage convolution process is performed on the image to be processed sequentially through multiple convolutional layers, so as to implement the first feature extraction process of the image to be processed and to obtain the first self-attention image. Similarly, a multi-stage convolution process may be performed on the image to be processed sequentially through the multiple convolutional layers, so as to implement the second feature extraction process of the image to be processed and to obtain the second self-attention image.

Optionally, before obtaining the first feature image by performing the convolution process on the image to be processed using the first convolution kernel, and obtaining the second feature image by performing the convolution process on the image to be processed using the second convolution kernel, a third feature extraction process may be performed on the image to be processed, so as to extract feature information of the image to be processed and to obtain a fifth feature image. The first feature image is obtained by performing the convolution process on the fifth feature image using the first convolution kernel, and the second feature image is obtained by performing the convolution process on the fifth feature image using the second convolution kernel. In such a manner, richer feature information may be extracted from the image to be processed.

Both the size of the first self-attention image and the size of the second self-attention image are the same as the size of the image to be processed. Each of the first self-attention image and second self-attention image may be used for representing the scale information of the image to be processed (i.e., the scales of different image regions in the image to be processed), and the scale information represented by the first self-attention image is different from the scale information represented by the second self-attention image. In the embodiment of the disclosure, the scale of the image (including the first feature image, the second feature image, the first self-attention image, the second self-attention image and the third self-attention image to be mentioned below, etc.) is matched with a receptive field of a convolution kernel adopted when a feature extraction process (including the first feature extraction process, the second feature extraction process and the third feature extraction process) is performed on the image to be processed. For example, when the scale of the image obtained by performing the convolution process on the image using a convolution kernel with a size of 3*3 is a and the scale of the image obtained by performing the convolution process on the image using a convolution kernel with a size of 5*5 is b, the scale of the self-attention image obtained by performing a feature extraction process on the image to be processed using the convolution kernel with the size of 3*3 is a (i.e., the self-attention image may represent the information of the image to be processed under the scale a), and the scale of a feature image obtained by performing the feature extraction process on the image to be processed using the convolution kernel with the size of 5*5 is b.

For example (the first example), the first self-attention image represents the information of the image to be processed under scale a, the second self-attention image represents the information of the image to be processed under scale b, and scale a is larger than scale b.

A range of a pixel value of a pixel in the first self-attention image and a range of a pixel value of a pixel in the second self-attention image are both more than or equal to 0, and less than or equal to 1. When the pixel value of a certain pixel in the first self-attention image (or the second self-attention image) is closer to 1, it means that the optimal scale of the pixel in the image to be processed at the same position as the certain pixel is closer to the scale represented by the first self-attention image (or the second self-attention image). In the embodiment of the disclosure, the optimal scale is a scale corresponding to an optimal receptive field of the pixel.

Still for the first example, pixel a and pixel b are two different pixels in the first self-attention image, pixel c is a pixel in the image to be processed at the same position as pixel a in the first self-attention image, and pixel d is a pixel in the image to be processed at the same position as pixel b in the first self-attention image. When the pixel value of pixel a is 0.9 and the pixel value of pixel b is 0.7, a difference between an optimal scale of pixel c and scale a is smaller than a difference between an optimal scale of pixel d and scale a.

In 502, a first weight of the first feature image is determined based on the first self-attention image, and a second weight of the second feature image is determined based on the second self-attention image.

Optionally, the scale represented by the first self-attention image is the same as the scale of the first feature image, and the scale represented by the second self-attention image is the same as the scale of the second feature image. In such a case, when the pixel value of the pixel in the first self-attention image is closer to 1, it means that the optimal scale of the pixel in the first feature image at the same position as the pixel in the first self-attention image is closer the scale of the first feature image, and when the pixel value of the pixel in the second self-attention image is closer to 1, it means that the optimal scale of the pixel in the second feature image at the same position as the pixel in the second self-attention image is closer to the scale of the second feature image.

Therefore, the first weight of the first feature image may be determined based on the first self-attention image, so as to adjust the scale of the pixel in the first feature image, and to allow the pixel in the first feature image to be closer to the optimal scale. Similarly, the second weight of the second feature image may be determined based on the second self-attention image, so as to adjust the scale of the pixel in the second feature image, and to allow the pixel in the second feature image to be closer to the optimal scale.

In a possible implementation, a third self-attention image corresponding to the first self-attention image and a fourth self-attention image corresponding to the second self-attention image may be obtained by performing a normalization process on the first self-attention image and second self-attention image. The third self-attention image is taken as the first weight, and the fourth self-attention image is taken as the second weight.

In the possible implementation, the normalization process is performed on the first self-attention image and second self-attention image, such that a sum of pixel values of pixels at the same positions in the first self-attention image and second self-attention image may be 1. For example, the position of pixel a in the first self-attention image is the same as the position of pixel b in the second self-attention image, and after the normalization process is performed on the first self-attention image and second self-attention image, the sum of the pixel values of pixel a and pixel b is 1. when the position of pixel c in the third self-attention image is the same as the position of pixel a in the first self-attention image, and the position of pixel d in the fourth self-attention image is the same as the position of pixel b in the second self-attention image, the sum of the pixel values of pixel c and pixel d is 1.

Optionally, the normalization process may be implemented through inputting the first self-attention image and second self-attention image to a softmax function respectively. It is to be understood that, when each of the first self-attention image and second self-attention image includes images of multiple channels, the images of the same channel in the first self-attention image and second self-attention image are input to the softmax function respectively. For example, when each of the first self-attention image and second self-attention image includes images of two channels, when the normalization process is performed on the first self-attention image and second self-attention image, the image of the first channel in the first self-attention image and the image of the first channel in the second self-attention image may be input to the softmax function, so as to obtain an image of a first channel in the third self-attention image and an image of a first channel in the fourth self-attention image.

In 503, the first crowd density image is obtained by performing the fusion process on the first feature image and second feature image based on the first weight and second weight.

Since the receptive field for the convolution process for obtaining the first feature image is different from the receptive field for the convolution process for obtaining the second feature image, the fusion process may be performed on the first feature image and second feature image by taking the third self-attention image as the first weight of the first feature image and taking the fourth self-attention image as the second weight of the second feature image, so as to implement convolution processes on different image regions in the image to be processed based on optimal receptive fields. In such a manner, the information of the different image regions in the image to be processed may be extracted fully, and the accuracy of the obtained crowd density image corresponding to the image to be processed is higher.

In an implementation of obtaining the first crowd density image by performing the fusion process on the first feature image and second feature image based on the first weight and second weight, a dot product of the first weight and first feature image is calculated to obtain a third feature image, and a dot product of the second weight and second feature image is calculated to obtain a fourth feature image. The first crowd density image may be obtained by performing the fusion process (for example, the addition of the pixel values at the same positions) on the third feature image and fourth feature image.

In the embodiment, the first feature extraction process and the second feature extraction process are performed on the image to be processed respectively, so as to extract the information of the image to be processed under the different scales, and to obtain the first self-attention image and second self-attention image. The first weight of the first feature image is determined based on the first self-attention image, the second weight of the second feature image is determined based on the second self-attention image, and the fusion process is performed on the first feature image and second feature image based on the first weight and second weight, such that the accuracy of the obtained first crowd density image may be improved.

In the first embodiment and the second embodiment, when the weight of the first convolution kernel is different from the weight of the second convolution kernel, a focus of the feature information extracted by performing the convolution process on the image to be processed using the first convolution kernel is different from a focus of the feature information extracted by performing the convolution process on the image to be processed using the second convolution kernel. For example, the convolution process performed on the image to be processed using the first convolution kernel focuses on extraction of an attribute feature (for example, a color of clothes and a length of trousers) of a person in the image to be processed, while the convolution process performed on the image to be processed using the second convolution kernel focuses on extraction of a contour feature (the contour feature may be used to recognize whether the image to be processed includes a person or not) of the person in the image to be processed. Then, considering that the receptive field of the first convolution kernel is different from the receptive field of the second convolution kernel, it is required to fuse different feature information under different scales (for example, the attribute feature under scale a is fused with the contour feature under scale b) when the fusion process is subsequently performed on the extracted first feature image and second feature image, which brings difficulties to the fusion of the scale information.

Therefore, the embodiment of the disclosure further provides a technical solution in which the weight of the first convolution kernel and the weight of the second convolution kernel are the same, so as to reduce the fusion of non-scale information during the fusion process of the first feature image and second feature image, improve the effect of scale information fusion, and further improve the accuracy of the obtained first crowd density image.

When the first convolution kernel and second convolution kernel are conventional convolution kernels and the receptive field of the first convolution kernel is different from the receptive field of the second convolution kernel, the weight of the first convolution kernel can't be the same as the weight of the second convolution kernel. Therefore, in the technical solution to be elaborated next, each of the first convolution kernel and second convolution kernel is an atrous convolution kernel, the size of the first convolution kernel is the same as the size of the second convolution kernel, the weight of the first convolution kernel is the same as the weight of the second convolution kernel, and the dilation rate of the first convolution kernel is different from the dilation rate of the second convolution kernel.

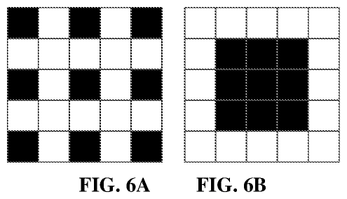

For example, two atrous convolution kernels are illustrated in FIG. 6A and FIG. 6B, and the sizes of the two atrous convolution kernels are both 3*3. The black regions in the atrous convolution kernel illustrated in FIG. 6A and the atrous convolution kernel illustrated in FIG. 6B indicate that there are parameters, and the white parts indicate that there are no parameters (i.e., the parameters are 0). Optionally, a weight of the atrous convolution kernel illustrated in FIG. 6A and a weight of the atrous convolution kernel illustrated in FIG. 6B may be the same. In addition, as can be seen from the figures, the dilation rate of the atrous convolution kernel illustrated in FIG. 6A is 2 and the dilation rate of the atrous convolution kernel illustrated in FIG. 6B is 1, such that the receptive field of the atrous convolution kernel illustrated in FIG. 6A is different from the receptive field of the atrous convolution kernel illustrated in FIG. 6B. Specifically, the receptive field (5*5) of the atrous convolution kernel illustrated in FIG. 6A is larger than the receptive field (3*3) of the atrous convolution kernel illustrated in FIG. 6B.

When each of the first convolution kernel and second convolution kernel is an atrous convolution kernel, the weight of the first convolution kernel may be the same as the weight of the second convolution kernel, and the receptive field of the first convolution kernel may be different from the receptive field of the second convolution kernel. In such a case, there is only a scale difference between the information included in the first feature image obtained by performing the convolution process on the image to be processed using the first convolution kernel and the information included in the second feature image obtained by performing the convolution process on the image to be processed using the second convolution kernel. When the fusion process is performed on the first feature image and second feature image, the accuracy of the obtained first crowd density image may be improved by better using the information of the image to be processed under different scales.

Optionally, the same group of weights may be shared by the first convolution kernel and second convolution kernel to allow the same weight of the first convolution kernel and second convolution kernel. As such, when the convolution processes are subsequently performed on the image to be processed using the first convolution kernel and second convolution kernel respectively, the number of parameters required to be processed may be reduced.

When the size of the atrous convolution kernel is fixed, the receptive field of the atrous convolution kernel is positively correlated with the dilation rate of the atrous convolution kernel. When the dilation rate of the atrous convolution kernel is 1, the receptive field of the atrous convolution kernel is the same as the receptive field of the conventional convolution kernel with the same size. For example, the dilation rate of the atrous convolution kernel illustrated in FIG. 6B is 1, and in such a case, the receptive field of the atrous convolution kernel is the same as the receptive field of the conventional convolution kernel with the size of 3*3.

Considering that there are pixel regions of relatively small optimal scales in the image to be processed, richer information may be extracted only by performing convolution processes on these image regions of relatively small scales based on relatively small receptive fields. The embodiment of the disclosure further provides a method of setting the dilation rate of the atrous convolution kernel to be 0 (i.e., a reference value), so as to allow the receptive field of the atrous convolution kernel to be smaller than the receptive field of the conventional convolution kernel, and to better extract the information of the image regions of relatively small scales in the image to be processed.

How to implement an atrous convolution kernel of which the dilation rate is 0 are theoretically inferred below.

Assuming a convolution process is performed on the image to be processed using an atrous convolution kernel of which the size is 3*3 and the dilation rate is d, the convolution process follows the formula below:

O_{(x,y)}=Σᵢ₌₋₁¹Σⱼ₌₋₁¹I_{(x+i+d,y+i+d)}*w_{(1+i,1+i)}+b Formula (1).

Herein, x and y denote a position of a center pixel of the atrous convolution kernel when the atrous convolution kernel slides to a certain pixel in the image to be processed, (x+i, y+i) is a coordinate, in the image to be processed, of a sampling point in the image to be processed, w_{(1+i,1+i)} is a weight of the atrous convolution kernel, b is a deviation of the atrous convolution kernel, I is the image to be processed, and O is a feature image obtained by performing the convolution process on the image to be processed using the atrous convolution kernel.

When d=0, Formula (1) may be converted into the following formula:

$${0}_{( x , y )} = {\sum }_{i = - 1}^{1} {\sum }_{j = - 1}^{1} {I}_{( x + i + 0 , y + i + 0 )} * {w}_{( 1 + i , 1 + i )} + b = {\sum }_{i = - 1}^{1} {\sum }_{j = - 1}^{1} {I}_{( x + i , y + i )} * {w}_{( 1 + i , 1 + i )} + b = {\sum }_{i = - 1}^{1} {\sum }_{j = - 1}^{1} ( {I}_{( x + i , y + i )} * {w}_{( 1 + i , 1 + i )} + \frac{b}{9} ) = {\sum }_{k = 1}^{9} {I}_{( x , y )} * {w}_{k}^{′} + {b}_{k}^{′} … . \qquad Formula ( 2 )$$

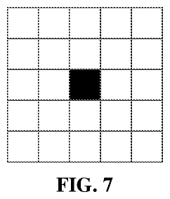

Herein, wₖ′ represents a weight of a conventional convolution kernel of which a size is 1*1, and bₖ′ represents a deviation of the conventional convolution kernel of which the size is 1*1. It can be seen from Formula (2) that performing the convolution process on the image to be processed using the atrous convolution kernel of which the size is 3*3 and the dilation rate is 0 is equivalent to performing convolution processes on the image to be processed using 9 conventional convolution kernels of which sizes are 1*1 respectively. Therefore, the atrous convolution kernel of which the dilation rate is 0 may be replaced with 9 1*1 conventional convolution kernels, i.e., all weights in the atrous convolution kernel of which the dilation rate is 0 are at the same position on the atrous convolution kernel. FIG. 7 illustrates the atrous convolution kernel of which the size is 3*3 and the dilation rate is 0, and the black region in the atrous convolution kernel illustrated in FIG. 6 is the position of the weight. It can be seen from the atrous convolution kernel illustrated in FIG. 6 that a receptive field of the atrous convolution kernel of which the dilation rate is 0 is 1.

In the embodiment of the disclosure, when the first convolution kernel is an atrous convolution kernel, the dilation rate of the first convolution kernel may be set to be 0 to implement the convolution process on the image to be processed based on the receptive field of 1 when the convolution process is performed on the image to be processed using the first convolution kernel, and to better extract information of an image region of a small scale in the image to be processed.

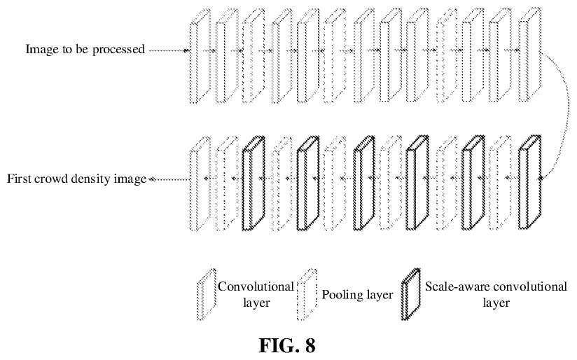

The embodiment of the disclosure further provides a crowd counting network, to implement the abovementioned technical solutions. Referring to FIG. 8, FIG. 8 is a structure diagram of a crowd counting network according to at least one embodiment of the disclosure. As illustrated in FIG. 8, the network layers in the crowd counting network are sequentially connected in series, totally including 11 convolutional layers, 9 pooling layers and 6 scale-aware convolutional layers.

The image to be processed is input to the crowd counting network. The image to be processed is processed through a first convolutional layer to obtain an image output by the first convolutional layer, the image output by the first convolutional layer is processed through a second convolutional layer to obtain an image output by the second convolutional layer, the image output by the second convolutional layer is processed through a first pooling layer to obtain an image output by the first pooling layer, . . . , an image output by a tenth convolutional layer is processed through a first scale-aware convolutional layer to obtain an image output by the first scale-aware convolutional layer, . . . , and an image output by a ninth pooling layer is processed through an eleventh convolutional layer to obtain the first crowd density image.

Optionally, the sizes of convolution kernels in all the convolutional layers, except the eleventh convolutional layer, in the crowd counting network may be 3*3, and the size of the convolution kernel in the eleventh convolutional layer is 1*1. Both the number of convolution kernels in the first convolutional layer and the number of convolution kernels in the second convolutional layer may be 64, both the number of convolution kernels in the third convolutional layer and the number of convolution kernels in the fourth convolutional layer may be 128, all of the number of convolution kernels in the fifth convolutional layer, the number of convolution kernels in the sixth convolutional layer and the number of convolution kernels in the seventh convolutional layer may be 256, all of the number of convolution kernels in the eighth convolutional layer, the number of convolution kernels in the ninth convolutional layer and the number of convolution kernels in the tenth convolutional layer may be 512, and the number of convolution kernels in the eleventh convolutional layer is 1.

The pooling layer in the crowd counting network may be a max pooling layer, or may be an average pooling layer. No limits are made thereto in the disclosure.

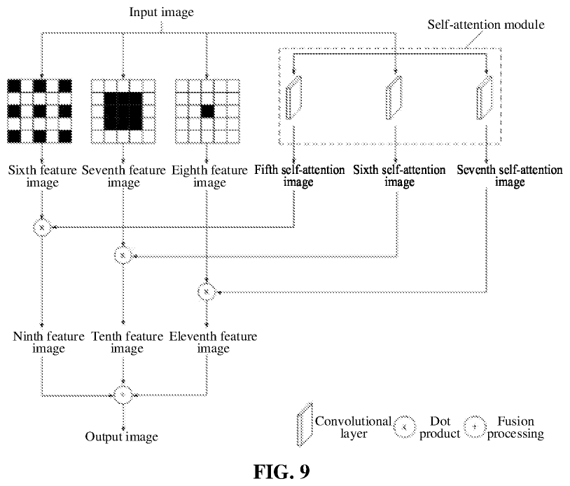

For the structure diagram of the scale-aware convolutional layer, references may be made to FIG. 9. As illustrated in FIG. 9, the scale-aware convolutional layer includes three atrous convolution kernels and one self-attention module. For the structures of the three atrous convolution kernels, references may be made to FIG. 6A, FIG. 6B and FIG. 7, which are not elaborated herein. The self-attention module includes three convolutional layers connected in parallel.

An input image of the scale-aware convolutional layer is processed through three atrous convolution kernels with different receptive fields respectively to obtain a sixth feature image, a seventh feature image and an eighth feature image respectively.

Convolution processes are performed on the input image of the scale-aware convolutional layer through the three convolutional layers in the self-attention module respectively to obtain a fifth self-attention image, a sixth self-attention image and a seventh self-attention image respectively.

A scale of the sixth feature image is the same as a scale of the fifth self-attention image, a scale of the seventh feature image is the same as a scale of the sixth self-attention image, and a scale of the eighth feature image is the same as a scale of the seventh self-attention image. A fusion process is performed on the sixth feature image, the seventh feature image and the eighth feature image by taking the fifth self-attention image as a weight of the sixth feature image, taking the sixth self-attention image as a weight of the seventh feature image and taking the seventh self-attention image as a weight of the eighth feature image, to obtain an output image of the scale-aware convolutional layer. That is, the dot product is performed on the fifth self-attention image and the sixth feature image to obtain a ninth feature image, the dot product is performed on the sixth self-attention image and the seventh feature image to obtain a tenth feature image, and the dot product is performed on the seventh self-attention image and the eighth feature image to obtain an eleventh feature image. The fusion process is performed on the ninth feature image, the tenth feature image and the eleventh feature image to obtain the output image of the scale-aware convolutional layer. Optionally, the fusion process may refer to adding the pixel values of pixels at the same positions in the two images subjected to the fusion process.

It is to be understood that the specific number of the network layers in the crowd counting network illustrated in FIG. 8 is only an example and should not form a limit to the application.

Before a crowd counting task is performed on the image to be processed using the crowd counting network illustrated in FIG. 8, it is required to train the crowd counting network. Therefore, the disclosure further provides a training method for the crowd counting network. The training method may include: obtaining a sample image, obtaining a second crowd density image by processing the sample image using the crowd counting network, obtaining a network loss based on a difference between the sample image and second crowd density image, and adjusting at least one parameter of the crowd counting network based on the network loss.

The sample image may be any digital image. For example, the sample image may include a person object. The sample image may merely include a face without trunk and limbs (the trunk and the limbs are hereafter referred to as a human body), or may merely include a human body without a face, or may merely include the lower limbs or the upper limbs. A specific human body region in the sample image is not limited in the disclosure. For another example, the sample image may include an animal. For still another example, the sample image may include a plant. The content in the sample image is not limited in the disclosure.

After obtaining the second crowd density image corresponding to the sample image by processing the sample image through the crowd counting network, the network loss of the crowd counting network may be determined based on the difference between the sample image and second crowd density image. The difference may be a difference between the pixel values of pixels at the same positions in the sample image and second crowd density image. In the embodiment of the disclosure, the pixel value of the pixel in the sample image may be used to represent whether there is a person at the pixel or not. For example, when an image region covered by person A in the sample image includes pixel a, pixel b and pixel c, then the pixel value of pixel a, the pixel value of pixel b and the pixel value of pixel c are all 1. When pixel d in the sample image does not belong to the image region covered by the person, the pixel value of the pixel is 0.

After the network loss of the crowd counting network is determined, the at least one parameter of the crowd counting network may be adjusted through a backward gradient propagation based on the network loss, and when the crowd counting network is converged, the training of the crowd counting network is completed.

The pixel value of the pixel in the sample image is either 0 or 1, and the pixel value of the pixel in the second crowd density image is a numerical value more than or equal to 0, and less than or equal to 1. Therefore, there may be relatively great differences among the network losses of the crowd counting network determined based on the difference between the sample image and second crowd density image.

Since the range of the pixel value of the pixel in the true crowd density image is also more than or equal to 0 and less than or equal to 1, optionally, the network loss of the crowd counting network may be determined based on a difference between the true crowd density image and second crowd density image through taking the true crowd density image of the sample image as supervision information, so as to improve the accuracy of the obtained network loss.

In a possible implementation, the true crowd density image of the sample image may be obtained based on an impulse function, a gaussian kernel and the sample image.

In the possible implementation, a person tag image of the sample image may be obtained based on the impulse function, and the pixel value of the pixel in the person tag image is used to represent whether the pixel belongs to the image region covered by the person or not. The person tag image follows the formula below:

H(x)=Σᵢ₌₁^{N}δ(x−xᵢ) Formula (3).

N is the total number of people in the sample image. xᵢ is the position, in the sample image, of the center of the image region covered by the person, and is used to represent the person. δ(x−xᵢ) is the impulse function of the position, in the sample image, of the center of the image region covered by the person in the sample image. When there is a person at x in the sample image, δ(x) is equal to 1. When there is no person at x in the sample image, δ(x) is equal to 0.

The true crowd density image of the sample image may be obtained by performing the convolution process on the person tag image using the gaussian kernel. The process follows the formulae below:

$$\begin{matrix}F ( x ) = {\sum }_{i = 1}^{N} δ ( x - {x}_{i} ) * {G}_{{σ}_{i}} ( x ) , where {σ}_{i} = β {d}_{i} , and & Formula ( 4 ) \\ {d}_{i} = \frac{1}{m} {\sum }_{j = 1}^{m} {d}_{j}^{i} . & Formula ( 5 )\end{matrix}$$

G_{σ}_{ᵢ}(x) is the gaussian kernel, σᵢ is a standard deviation of the gaussian kernel, β is a positive number, and dᵢ is an average value of distances between m persons closest to person xᵢ and xᵢ. It is apparent that, the greater dᵢ is, the higher the crowd density of the image region covered by the person corresponding to dᵢ is. Since dᵢ of a person far away in the sample image is smaller than dᵢ of a person close up, the standard deviation of the gaussian kernel may be positively correlated with the scale of the image region covered by the person through setting the standard deviation of the gaussian kernel to meet σᵢ=βdᵢ, i.e., different image regions in the sample image correspond to different standard deviations of the gaussian kernel. Therefore, the accuracy of the true crowd density image obtained by performing the convolution process on the sample image using the gaussian kernel is higher.

For example, in Formula (3), xᵢ is the position of the center (referred to as the center of the head region hereinafter), in the sample image, of the image region covered by the head of the person in the sample image, and δ(x−xᵢ) is the impulse function of the position of the center of the head region in the sample image. When there is a head at x in the sample image, δ(x) is equal to 1. When there is no head at x in the sample image, δ(x) is equal to 0. The true crowd density image of the sample image is obtained by performing the convolution process on the person tag image using the gaussian kernel based on Formula (4). The standard deviation of the gaussian kernel used for the convolution process of the i-th head in the person tag image meets σᵢ=βdᵢ, where dᵢ is an average distance between the center of the i-th head in the person tag image and the centers of m target heads (herein, the target head is the head in the person tag image closest to the i-th head). Under a normal condition, the size of the head is correlated with the distance between the centers of two adjacent persons in a crowded scene, and dᵢ is approximately equal to the size of the head in the dense crowd. Since the acreage of the image region covered by a head “close up” in the person tag image is larger than the acreage of the image region covered by a head “far away”, i.e., the distance between the centers of two heads “close up” in the person tag image is greater than the distance between the centers of two heads “far away”, the standard deviation of the gaussian kernel may be set to meet σᵢ=βdᵢ, so as to achieve that the standard deviation of the gaussian kernel is positively correlated with the scale of the image region covered by the head of the person.

After the true crowd density image of the sample image is obtained, the network loss of the crowd counting network may be determined based on a difference between the pixel values of the pixels at the same position in the true crowd density image and second crowd density image. For example, the sum of differences between the pixel values of the pixels at all the same positions in the true crowd density image and second crowd density image is taken as the network loss of the crowd counting network.

Optionally, before the sample image is input to the crowd counting network, the sample image may be pre-processed to obtain at least one pre-processed image, and the at least one pre-processed image is input to the crowd counting network as training data. As such, the training dataset of the crowd counting network may be expanded.

The pre-processing includes at least one of intercepting an image of a predetermined size from the sample image, or performing a flipping process on the sample image or the image of the predetermined size. The predetermined size may be 64*64. The flipping process on the sample image includes a horizontal mirror flipping process.

For example, the sample image may be segmented along a horizontal central axis and vertical central axis of the sample image respectively to obtain four pre-processed images. Meanwhile, five images of the predetermined size may be randomly intercepted from the sample image to obtain five pre-processed images. As such, nine pre-processed images have been obtained. The horizontal mirror flipping process may be performed on the nine pre-processed images to obtain nine flipped images, i.e., other nine pre-processed images. As such, 18 pre-processed images may be obtained.

The at least one pre-processed image may be input to the crowd counting network to obtain at least one third crowd density image, each pre-processed image corresponding to one third crowd density image. For example (the second example), three pre-processed images, i.e., image A, image B and image C, are input to the crowd counting network respectively to obtain crowd density image a corresponding to image A, crowd density image b corresponding to image B and crowd density image c corresponding to image C respectively. All of crow density image a, crowd density image b and crowd density image c may be called the third crowd density images.

The network loss of the crowd counting network may be obtained based on the difference between the target image in the at least one pre-processed image and the third crowd density image corresponding to the target image. Still in the second example, the first difference may be obtained based on the difference between image A and the image a, the second difference may be obtained based on the difference between image B and image b, and the third difference may be obtained based on the difference between image C and image c. The first difference, the second difference and the third difference may be summed to obtain the network loss of the crowd counting network.

The embodiment provides a crowd counting network. The image to be processed may be processed using the crowd counting network to obtain the crowd density image corresponding to the image to be processed, and to further determine the number of the people in the image to be processed.

Based on the technical solutions provided in the embodiments of the disclosure, the embodiments of the disclosure further provide some possible application scenarios.

In Scenario A, as described above, too much human traffic in a public place usually causes overcrowding and further causes some public accidents, and how to implement the crowd counting for the public place is of great significance.

At present, in order to enhance the safety in a working, living or social environment, surveillance camera equipment may be mounted in each public place for safety protection according to video stream information. The video stream acquired by the surveillance camera equipment may be processed with the technical solutions provided in the embodiments of the disclosure, so as to determine the number of people in the public place, and to further prevent public accidents effectively.

For example, the server of the video stream processing center of the surveillance camera equipment may implement the technical solutions provided in the embodiments of the disclosure. The server may be connected to at least one surveillance camera. The server, after obtaining the video stream sent by the surveillance camera, may process each frame of image in the video stream with the technical solutions provided in the embodiments of the disclosure, so as to determine the number of people in each frame of image in the video stream. When the number of people in the image is more than or equal to a threshold of the number of people, the server may send an instruction to related equipment for prompting or alarming. For example, the server may send an instruction to the camera acquiring the image, which is configured to instruct the camera acquiring the image to alarm. For another example, the server may send an instruction to a terminal of control center of a region where the camera acquiring the image is, which is configured to prompt the terminal to output prompting information prompting that the number of the people is greater than the threshold of the number of people.

In Scenario B, different regions in the market have different human traffic, and exhibiting main products in regions with great human traffic may improve sales of the main products effectively. Therefore, how to determine the human traffic in different regions in the market accurately is of great significant for merchants. For example, there are region A, region B and region C in the market, and the human traffic in region B is the maximum. Based on this, the merchants may exhibit the main products in region B to improve the sales of the main products.

The server of control center of the video stream of the surveillance camera in the market may implement the technical solutions provided in the embodiments of the disclosure. The server may be connected to at least one surveillance camera. The server, after obtaining the video stream sent by the surveillance camera, may process each frame of image in the video stream with the technical solutions provided in the embodiments of the disclosure, so as to determine the number of people in each frame of image in the video stream. The human traffic in regions monitored by different cameras over a certain period of time may be determined based on the number of people in each frame of image, and furthermore, the human traffic in different regions in the market may be determined. For example, there is region A, region B, region C, camera A, camera B and camera C in the market, camera A monitors region A, camera B monitors region B, and camera C monitors region C. The server processes the image in the video stream acquired by camera A with the technical solutions provided in the embodiments of the disclosure, and determines that the average daily human traffic in region A in the last week is 900, the average daily human traffic in the last week in region A is 900, the average daily human traffic in region B in the last week is 200, and the average daily human traffic in region C in the last week is 600. It is apparent that the human traffic in region A is the maximum, and therefore, the merchants may exhibit the main products in region A to improve the sales of the main products.

It can be understood by those skilled in the art that, in the methods in the specific implementations, the description sequence for the steps does not mean a strict execution sequence and is not intended to form any limit to the implementation, and the specific execution sequence for the steps should be determined based on the functions and probable internal logic thereof.

The methods of the embodiments of the disclosure are elaborated above, and a device of the embodiments of the disclosure is provided below.

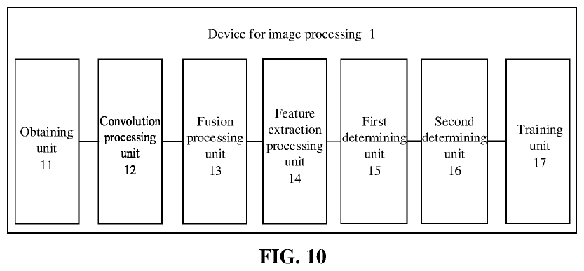

Referring to FIG. 10, FIG. 10 is a structure diagram of a device for image processing according to at least one embodiment of the disclosure. Device 1 includes an obtaining unit 11, a convolution processing unit 12, a fusion processing unit 13, a feature extraction processing unit 14, a first determining unit 15, a second determining unit 16 and a training unit 17.

The obtaining unit 11 is configured to obtain an image to be processed, a first convolution kernel, and a second convolution kernel. A receptive field of the first convolution kernel is different from a receptive field of the second convolution kernel.

The convolution processing unit 12 is configured to obtain a first feature image by performing a convolution process on the image to be processed using the first convolution kernel, and obtain a second feature image by performing a convolution process on the image to be processed using the second convolution kernel.

The fusion processing unit 13 is configured to obtain a first crowd density image by performing a fusion process on the first feature image and second feature image.

In a possible implementation, device 1 further includes a feature extraction processing unit 14 and a first determining unit 15.

The feature extraction processing unit 14 is configured to obtain, before obtaining the first crowd density image by performing the fusion process on the first feature image and second feature image, a first self-attention image by performing a first feature extraction process on the image to be processed, and obtain a second self-attention image by performing a second feature extraction process on the image to be processed, each of the first self-attention image and second self-attention image being used for representing a scale information of the image to be processed, and the scale information represented by the first self-attention image being different from the scale information represented by the second self-attention image.

The first determining unit 15 is configured to determine a first weight of the first feature image based on the first self-attention image, and determine a second weight of the second feature image based on the second self-attention image.

The fusion processing unit 13 is configured to:

obtain the first crowd density image by performing the fusion process on the first feature image and second feature image based on the first weight and second weight.

In another possible implementation, the fusion processing unit 13 is specifically configured to:

obtain a third feature image by determining a dot product of the first weight and first feature image;

obtain a fourth feature image by determining a dot product of the second weight and second feature image; and

obtain the first crowd density image by performing a fusion process on the third feature image and fourth feature image.

In still another possible implementation, the first determining unit 15 is configured to:

obtain a third self-attention image corresponding to the first self-attention image and a fourth self-attention image corresponding to the second self-attention image by performing a normalization process on the first self-attention image and second self-attention image; and

take the third self-attention image as the first weight and the fourth self-attention image as the second weight.

In yet another possible implementation, the feature extraction processing unit 14 is further configured to obtain a fifth feature image by performing a third feature extraction process on the image to be processed to, before obtaining the first feature image by performing the convolution process on the image to be processed using the first convolution kernel, and obtaining the second feature image by performing the convolution process on the image to be processed using the second convolution kernel.

The convolution processing unit 12 is configured to:

obtain the first feature image by performing a convolution process on the fifth feature image using the first convolution kernel, and obtain the second feature image by performing a convolution process on the fifth feature image using the second convolution kernel.

The feature extraction processing unit 14 is further configured to:

obtain the first self-attention image by performing the first feature extraction process on the fifth feature image, and obtain the second self-attention image by performing the second feature extraction process on the fifth feature image.

In another possible implementation, each of the first convolution kernel and second convolution kernel is an atrous convolution kernel, a size of the first convolution kernel is the same as a size of the second convolution kernel, a weight of the first convolution kernel is the same as a weight of the second convolution kernel, and a dilation rate of the first convolution kernel is different from a dilation rate of the second convolution kernel.

In another possible implementation, the dilation rate of the first convolution kernel or the dilation rate of the second convolution kernel is a reference value.

In another possible implementation, device 1 further includes a second determining unit 16, configured to obtain a number of people in the image to be processed by determining a sum of pixel values in the first crowd density image.

In another possible implementation, the method for image processing performed by the device 1 is applied to a crowd counting network.

The device 1 further includes a training unit 17, configured to perform a training process on the crowd counting network. The training process of the crowd counting network includes:

obtaining a sample image,

processing the sample image using the crowd counting network to obtain a second crowd density image,

obtaining a network loss based on a difference between the sample image and second crowd density image, and

adjusting at least one parameter of the crowd counting network based on the network loss.

In another possible implementation, the training unit 17 is further configured to:

obtain a true crowd density image of the sample image based on an impulse function, a gaussian kernel and the sample image, before obtaining the network loss based on the difference between the sample image and second crowd density image; and

obtain the network loss based on a difference between the true crowd density image and second crowd density image.

In another possible implementation, the training unit 17 is further configured to:

obtain at least one pre-processed image by pre-processing the sample image, before obtaining the second crowd density image by processing the sample image using the crowd counting network;

obtain at least one third crowd density image by processing the at least one pre-processed image using the crowd counting network, there being a one-to-one correspondence between the pre-processed image and third crowd density image; and

obtain the network loss based on a difference between a target image in the at least one pre-processed image and a third crowd density image corresponding to the target image.

In another possible implementation, the pre-processing includes at least one of intercepting an image of a predetermined size from the sample image, or performing a flipping process on the sample image or the image of the predetermined size.

In the embodiment, the convolution processes are performed on the image to be processed using the first convolution kernel and second convolution kernel with different receptive fields respectively, so as to extract the information describing the content of the image to be processed under different scales, and to obtain the first feature image and second feature image respectively. The fusion process is performed on the first feature image and second feature image, so as to improve the accuracy of the obtained crowd density image corresponding to the image to be processed using the information describing the content of the image to be processed under different scales, and to further improve the accuracy of the obtained number of the people in the image to processed.

In some embodiments, the functions or modules of the device provided in the embodiment of the disclosure may be configured to perform the method described in the method embodiment, and for the specific implementation thereof, references may be made to the description regarding the method embodiment, which are not elaborated herein for simplicity.

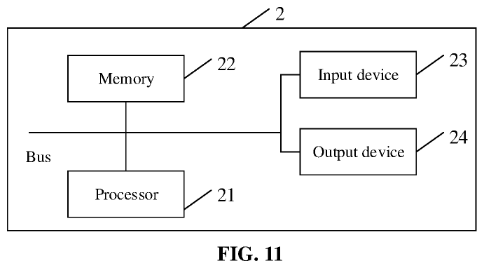

FIG. 11 is a hardware structure diagram of a device for image processing according to at least one embodiment of the disclosure. Device 2 for image processing includes a processor 21 and a memory 22, and may further include an input device 23 and an output device 24. The processor 21, the memory 22, the input device 23 and the output device 24 are coupled via a connector. The connector includes various interfaces, transmission lines or bus, etc. No limits are made thereto in the embodiment of the disclosure. It is to be understood that, in each embodiment of the disclosure, the coupling refers to interconnection implemented in a specific manner, including direct connection or indirect connection through another device, such as connection via various interfaces, transmission lines and bus.

The processor 21 may be one or more Graphics Processing Units (GPUs). When the processor 21 is one GPU, the GPU may be a single-core GPU or may be a multi-core GPU. Optionally, processor 21 may be a set of processors consisting of multiple GPUs, and the multiple processors are coupled with one another via one or more bus. Optionally, the processor may further be a processor of another type or the like. No limits are made in the embodiment of the disclosure.

The memory 22 is configured to store computer program instructions and various computer program codes including program codes configured to implement the solutions of the disclosure. Optionally, the memory includes, but is not limited to, a Random Access Memory (RAM), a Read-Only Memory (ROM), an Erasable Programmable ROM (EPROM) or a Compact Disc Read-Only Memory (CD-ROM). The memory is configured for related instructions and data.

The input device 23 is configured to input data and signals, and the output device 24 is configured to output data and signals. The input device 23 and the output device 24 may be independent devices, or may be one integrated device.

It is to be understood that, in the embodiment of the disclosure, the memory 22 may be not only configured to store related instructions but also be configured to store related images. For example, the memory 22 is configured to store an image to be processed acquired by the input device 23, or the memory 22 may be further configured to store a first crowd density image obtained by the processor 21, or the like. The data specifically stored in the memory is not limited in the embodiment of the disclosure.

It is to be understood that FIG. 11 only illustrates a simplified design of the device for image processing. In a practical application, the device for image processing may further include other required components, including, but not limited to, any number of input/output devices, processors, memories or the like. All devices for image processing capable of implementing the embodiments of the disclose fall within the scope of protection of the disclosure.

The embodiment of the disclosure further provides a processor. Computer programs may be stored in a cache of the processor. When the computer programs are executed by the processor, the processor may implement the technical solutions provided in the first embodiment and the second embodiment or implement the processing on the image to be processed by the trained crowd counting network.

Those skilled in the art may understand that the units and algorithm steps of each example described in the embodiments of the disclosure may be implemented by electronic hardware or a combination of computer software and electronic hardware. Whether these functions are implemented in the form of hardware or software depends on specific applications and design constraints of the technical solutions. Professionals may achieve the described functions for each specific application using different methods, but such achievement shall fall within the scope of the disclosure.

Those skilled in the art may clearly understand that, for the specific working processes of the system, device and unit described above, references may be made to the corresponding processes in the method embodiments, which are not elaborated herein for ease and simplicity of description. Those skilled in the art may further clearly know that the embodiments of the disclosure are described with different focuses. For ease and simplicity of description, the elaboration regarding the same or similar parts may be omitted in different embodiments, and thus, for the parts that are not described or detailed in one embodiment, references may be made to the records of other embodiments.

In the embodiments provided by the application, it is to be understood that the disclosed system, device and method may be implemented in other manners. For example, the device embodiment described above is only illustrative. For example, the division of the units is only division for logic functions, and other manners for division may be adopted in practical implementation. For example, multiple units or components may be combined or integrated into another system, or some features may be omitted or not executed. In addition, the coupling, direct coupling or communication connection to each other displayed or discussed above may be indirect coupling or communication connection via some interfaces, devices or units, and may be electrical, mechanical or in other forms.

The units described as separate parts may or may not be physically separated, and the parts displayed as units may or may not be physical units, i.e., the parts may be located in the same place, or may be distributed to multiple network units. Part or all of the units may be selected to achieve the purposes of the solutions of the embodiments according to practical requirements.

In addition, the respective functional unit in each embodiment of the disclosure may be integrated into a processing unit, or the respective units may physically exist independently, or two or more units may be integrated into one unit.

The embodiments may be implemented comprehensively or partially using software, hardware, firmware or any combination thereof. In the implementation using software, the embodiments may be implemented comprehensively or partially in the form of a computer program product. The computer program product includes one or more computer instructions. When the computer program instruction is loaded and executed on a computer, the flows or functions according to the embodiments of the disclosure are comprehensively or partially generated. The computer may be a universal computer, a dedicated computer, a computer network or another programmable device. The computer instruction may be stored in a computer-readable storage medium or transmitted through the computer-readable storage medium. The computer instruction may be transmitted from one web site, computer, server or data center to another web site, computer, server or data center in a wired (for example, a coaxial cable, an optical fiber and a Digital Subscriber Line (DSL)) or wireless (for example, infrared, radio and microwave) manner. The computer-readable storage medium may be any available medium accessible for the computer, or a data storage device including one or more integrated available mediums such as a server and a data center. The available medium may be a magnetic medium (for example, a floppy disk, a hard disk and a magnetic tape), an optical medium (for example, a Digital Versatile Disc (DVD)), a semiconductor medium (for example, a Solid State Disk (SSD)) or the like.

It is to be understood by those skilled in the art that all or part of the flows in the methods of the abovementioned embodiments may be implemented by means of instructing related hardware by a computer program, the program may be stored in a volatile and nonvolatile computer-readable storage medium, and when the program is executed, the flows of the method embodiments may be included. The storage medium includes: various medium capable of storing program codes such as a ROM, a RAM, a magnetic disk or an optical disk.

1. A method for image processing, comprising:
obtaining an image to be processed, a first convolution kernel and a second convolution kernel, a receptive field of the first convolution kernel being different from a receptive field of the second convolution kernel;
obtaining a first feature image by performing a convolution process on the image to be processed using the first convolution kernel, and obtaining a second feature image by performing a convolution process on the image to be processed using the second convolution kernel; and
obtaining a first crowd density image by performing a fusion process on the first feature image and second feature image.

2. The method of claim 1, wherein the method further comprises: before obtaining the first crowd density image by performing the fusion process on the first feature image and second feature image,
obtaining a first self-attention image by performing a first feature extraction process on the image to be processed, and obtaining a second self-attention image by performing a second feature extraction process on the image to be processed, each of the first self-attention image and second self-attention image being used for representing scale information of the image to be processed, and the scale information represented by the first self-attention image being different from the scale information represented by the second self-attention image; and
determining a first weight of the first feature image based on the first self-attention image, and determining a second weight of the second feature image based on the second self-attention image, wherein
obtaining the first crowd density image by performing the fusion process on the first feature image and second feature image comprises:
obtaining the first crowd density image by performing the fusion process on the first feature image and second feature image based on the first weight and second weight.

3. The method of claim 2, wherein obtaining the first crowd density image by performing the fusion process on the first feature image and second feature image based on the first weight and second weight comprises:
obtaining a third feature image by determining a dot product of the first weight and first feature image;
obtaining a fourth feature image by determining a dot product of the second weight and second feature image; and
obtaining the first crowd density image by performing a fusion process on the third feature image and fourth feature image.

4. The method of claim 2, wherein determining the first weight of the first feature image based on the first self-attention image, and determining the second weight of the second feature image based on the second self-attention image comprises:
obtaining a third self-attention image corresponding to the first self-attention image and a fourth self-attention image corresponding to the second self-attention image by performing a normalization process on the first self-attention image and second self-attention image; and
taking the third self-attention image as the first weight and the fourth self-attention image as the second weight.

5. The method of claim 2, wherein the method further comprises: before obtaining the first feature image by performing the convolution process on the image to be processed using the first convolution kernel, and obtaining the second feature image by performing the convolution process on the image to be processed using the second convolution kernel,
obtaining a fifth feature image by performing a third feature extraction process on the image to be processed, wherein
obtaining the first feature image by performing the convolution process on the image to be processed using the first convolution kernel, and obtaining the second feature image by performing the convolution process on the image to be processed using the second convolution kernel comprises:
obtaining the first feature image by performing a convolution process on the fifth feature image using the first convolution kernel, and obtaining the second feature image by performing a convolution process on the fifth feature image using the second convolution kernel; and
obtaining the first self-attention image by performing the first feature extraction process on the image to be processed, and obtaining the second self-attention image by performing the second feature extraction process on the image to be processed comprises:
obtaining the first self-attention image by performing the first feature extraction process on the fifth feature image, and obtaining the second self-attention image by performing the second feature extraction process on the fifth feature image.

6. The method of claim 1, wherein each of the first convolution kernel and second convolution kernel is an atrous convolution kernel, a size of the first convolution kernel is the same as a size of the second convolution kernel, a weight of the first convolution kernel is the same as a weight of the second convolution kernel, and a dilation rate of the first convolution kernel is different from a dilation rate of the second convolution kernel.

7. The method of claim 6, wherein the dilation rate of the first convolution kernel or the dilation rate of the second convolution kernel is a reference value.

8. The method of claim 1, further comprising: determining a sum of pixel values in the first crowd density image to obtain a number of people in the image to be processed.

9. The method of claim 1, wherein the method is applied to a crowd counting network; and
a training process of the crowd counting network comprises:
obtaining a sample image,
obtaining a second crowd density image by processing the sample image using the crowd counting network,
obtaining a network loss based on a difference between the sample image and second crowd density image, and
adjusting at least one parameter of the crowd counting network based on the network loss.

10. The method of claim 9, wherein the method further comprises: before obtaining the network loss based on the difference between the sample image and second crowd density image,
obtaining a true crowd density image of the sample image, wherein
obtaining the network loss based on the difference between the sample image and second crowd density image comprises:
obtaining the network loss based on a difference between the true crowd density image and second crowd density image.

11. The method of claim 9, wherein the method further comprises: before obtaining the second crowd density image by processing the sample image using the crowd counting network,
pre-processing the sample image to obtain at least one pre-processed image, wherein
obtaining the second crowd density image by processing the sample image using the crowd counting network comprises:
obtaining at least one third crowd density image by processing the at least one pre-processed image using the crowd counting network, there being a one-to-one correspondence between the pre-processed image and third crowd density image; and
obtaining the network loss based on the difference between the sample image and second crowd density image comprises:
obtaining the network loss based on a difference between a target image in the at least one pre-processed image and a third crowd density image corresponding to the target image.

12. The method of claim 11, wherein the pre-processing comprises at least one of: intercepting an image of a predetermined size from the sample image, or performing a flipping process on the sample image or the image of the predetermined size.

13. A device for image processing, comprising:
a processor; and
a memory for storing processor-executable instructions;
wherein the processor is configured to execute the processor-executable instructions to perform operations of:
obtaining an image to be processed, a first convolution kernel, and a second convolution kernel, a receptive field of the first convolution kernel being different from a receptive field of the second convolution kernel;
obtaining a first feature image by performing a convolution process on the image to be processed using the first convolution kernel, and obtaining a second feature image by performing a convolution process on the image to be processed using the second convolution kernel; and
obtaining a first crowd density image by performing a fusion process on the first feature image and second feature image.

14. The device of claim 13, wherein the processor is further configured to execute the processor-executable instructions to perform operations of:
before obtaining the first crowd density image by performing the fusion process on the first feature image and second feature image, obtaining a first self-attention image by performing a first feature extraction process on the image to be processed, and obtaining a second self-attention image by performing a second feature extraction process on the image to be processed, each of the first self-attention image and second self-attention image being used for representing a scale information of the image to be processed, and the scale information represented by the first self-attention image being different from the scale information represented by the second self-attention image; and
determining a first weight of the first feature image based on the first self-attention image, and determining a second weight of the second feature image based on the second self-attention image, wherein
wherein the processor is further configured to execute the processor-executable instructions to perform an operation of:
obtaining the first crowd density image by performing the fusion process on the first feature image and second feature image based on the first weight and second weight.

15. The device of claim 14, wherein the processor is further configured to execute the processor-executable instructions to perform operations of:
obtaining a third feature image by determining a dot product of the first weight and first feature image;
obtaining a fourth feature image by determining a dot product of the second weight and second feature image; and
obtaining the first crowd density image by performing a fusion process on the third feature image and fourth feature image.

16. The device of claim 14, wherein the processor is further configured to execute the processor-executable instructions to perform operations of:
obtaining a third self-attention image corresponding to the first self-attention image and a fourth self-attention image corresponding to the second self-attention image by performing a normalization process on the first self-attention image and second self-attention image; and
taking the third self-attention image as the first weight and the fourth self-attention image as the second weight.

17. The device of claim 14, wherein the processor is further configured to execute the processor-executable instructions to perform operations of: obtaining a fifth feature image by performing a third feature extraction process on the image to be processed, before obtaining the first feature image by performing the convolution process on the image to be processed using the first convolution kernel and obtaining the second feature image by performing the convolution process on the image to be processed using the second convolution kernel;
obtaining the first feature image by performing a convolution process on the fifth feature image using the first convolution kernel, and obtaining the second feature image by performing a convolution process on the fifth feature image using the second convolution kernel; and
obtaining the first self-attention image by performing the first feature extraction process on the fifth feature image, and obtaining the second self-attention image by performing the second feature extraction process on the fifth feature image.

18. The device of claim 13, wherein each of the first convolution kernel and second convolution kernel is an atrous convolution kernel, a size of the first convolution kernel is the same as a size of the second convolution kernel, a weight of the first convolution kernel is the same as a weight of the second convolution kernel, and a dilation rate of the first convolution kernel is different from a dilation rate of the second convolution kernel.

19. The device of claim 13, wherein a method for image processing performed by the device is applied to a crowd counting network;
wherein the processor is further configured to execute the processor-executable instructions to perform operations of:
performing a training process on the crowd counting network; and the training process of the crowd counting network comprises:
obtaining a sample image,
processing the sample image using the crowd counting network to obtain a second crowd density image,
obtaining a network loss based on a difference between the sample image and second crowd density image, and
adjusting at least one parameter of the crowd counting network based on the network loss.

20. A non-transitory computer-readable storage medium having stored thereon a computer program comprising program instructions that when executed by a processor of electronic equipment, cause the processor to perform a method for image processing, the method comprising:
obtaining an image to be processed, a first convolution kernel and a second convolution kernel, a receptive field of the first convolution kernel being different from a receptive field of the second convolution kernel;
obtaining a first feature image by performing a convolution process on the image to be processed using the first convolution kernel, and obtaining a second feature image by performing a convolution process on the image to be processed using the second convolution kernel; and
obtaining a first crowd density image by performing a fusion process on the first feature image and second feature image.
